(19) United States
(12) Patent Application Publication
(10) Pub. No.: US 2013/0054184 A1
(43) Pub. Date: Feb. 28, 2013

(54) VELOCITY CALCULATION METHOD, VELOCITY CALCULATION APPARATUS, AND STORAGE MEDIUM

(71) Applicants: Nobuya Sakai, Tokyo (JP); Atsuo Kumekawa, Tokyo (JP)

(72) Inventors: Nobuya Sakai, Tokyo (JP); Atsuo Kumekawa, Tokyo (JP)

(21) Appl. No.: 13/592,114

(22) Filed: Aug. 22, 2012

(30) Foreign Application Priority Data
Aug. 22, 2011 (JP) P2011-180800
Jun. 11, 2012 (JP) P2012-131582

(51) Int. Cl. G06F 15/00

(52) U.S. Cl. 702/142

(57) ABSTRACT

A velocity calculation apparatus (100) includes an acceleration sensor (10), an Acc integration unit (20), and a control unit (50). The acceleration sensor (10) measures acceleration of a walking or running subject. The Acc integration unit (20) integrates the acceleration measured by the acceleration sensor (10), during a unit time (UT) longer than the walking or running cycle, thus to generate an integrated synthetic value. The control unit (50) applies the integrated synthetic value to an approximation established in advance so as to calculate the velocity (v) of the subject. With such operation that barely imposes computational load, the velocity (v) of the subject can be calculated with practically acceptable accuracy.

This application is based on Japanese patent applications NO.2011-180800 and No.2012-131582, the contents of which are incorporated hereinto by reference.

### BACKGROUND

1. Technical Field

The present invention relates to a velocity calculation method and a velocity calculation apparatus to be used for measuring walking speed or running speed of a subject, and to a storage medium on which a computer program for operating the velocity calculation apparatus is stored.

2. Related Art

For those who practice exercises such as walking and jogging, it is important to know the walking speed or running speed on a real-time basis.

Various methods of measuring velocity of a moving subject have thus far been developed. To cite a few examples, a global positioning system (GPS) speedometer that utilizes signals transmitted from an artificial satellite, and a speedometer that calculates velocity on the basis of measurement results of an acceleration sensor are known. However, the GPS speedometer has to have a functional unit for communication with the artificial satellite, and hence the apparatus structure inevitably becomes complicated. Moreover, the positioning accuracy of the GPS speedometer is not so high, and therefore it is impossible to measure with practically acceptable accuracy the speed of a slowly moving subject, such as a walking or jogging person.

From the viewpoint of the principle of measurement, the velocity calculation apparatus that utilizes the acceleration sensor can be broadly classified into one that calculates the velocity on the basis of counts of the number of steps (for example, JP-A-H5-164571) and another that calculates the velocity on the basis of a walking cycle obtained by frequency analysis of an acceleration waveform (for example, JP-A-2004-358229).

The apparatus according to JP-A-H5-164571 estimates a covered distance by multiplying a preset stride length by the number of steps, and divides the covered distance by measurement time to thereby calculate the velocity. The apparatus according to JP-A-2004-358229 obtains a power spectrum by frequency analysis of the measured acceleration waveform, and statistically calculates the stride length from a peak value of the spectrum. More specifically, this apparatus calculates the walking cycle from the frequency corresponding to the peak value of the power spectrum, and multiplies the stride length by the walking cycle, thus to calculate the walking velocity.
[Patent document 1] JP-A-H5-164571
[Patent document 2] JP-A-2004-358229

### SUMMARY

With the apparatus according to JP-A-H5-164571, however, the stride length of the subject has to be set in advance at a fixed value (for example, 60 cm), which leads to lower calculation accuracy of the velocity. This is because the relationship between the walking velocity and the stride length widely varies among the subjects. In order to walk faster, some subjects extend the stride length keeping the walking cycle (pitch) unchanged, while others increase the walking cycle. Such variation of the stride length is not taken into account in the apparatus according to JP-A-H5-164571, and hence a change in walking velocity arising from the change in stride length is not reflected in the calculation. Accordingly, in the case where the subject is of the type who changes the walking velocity by adjusting the stride length without changing the walking cycle (pitch), it is difficult for the apparatus according to JP-A-H5-164571 to calculate the walking velocity with practically acceptable accuracy. Regarding the measurement error that may be incurred by the apparatus according to JP-A-H5-164571 will be subsequently described, with reference to a comparative example.

The JP-A-2004-358229 is configured to perform the frequency analysis of the acceleration waveform, which imposes a significant computational burden on the apparatus, and it is difficult to calculate the walking velocity on a real-time basis. The apparatus according to JP-A-2004-358229 is basically designed to record the acceleration of a moving subject, and to perform the frequency analysis after the exercise by using a computer. In order to obtain the walking velocity on a real-time basis with the apparatus according to JP-A-2004-358229, a power-consuming processing unit (CPU) having a sufficient capacity is necessary, which requires a large-scale system.

The foregoing drawbacks are incidental to both walking and running exercises of the subject. The present invention has been accomplished in view of such problems, and provides a method and an apparatus capable of calculating walking or running velocity with practically acceptable accuracy, with a simple structure.

In one embodiment, there is provided a velocity calculation method including measuring acceleration of a walking or running subject, integrating the acceleration during a unit time longer than a walking or running cycle thus obtaining an integrated synthetic value, and applying the integrated synthetic value to an approximation established in advance, thereby calculating velocity of the subject.

In another embodiment, there is provided a velocity calculation apparatus including an acceleration sensor that measures acceleration of a walking or running subject, an integration unit that integrates the acceleration during a unit time longer than a walking or running cycle thus to obtain an integrated synthetic value, a storage unit containing an approximation established in advance, and a velocity calculation unit that refers the storage unit and applies the integrated synthetic value to the approximation to thereby calculate velocity of the subject.

In still another embodiment, there is provided a storage medium having a computer program stored thereon for causing a velocity calculation apparatus including an acceleration sensor that measures acceleration of a walking or running subject to perform a velocity calculation process, wherein the velocity calculation process includes integrating the acceleration measured by the acceleration sensor during a unit time longer than a walking or running cycle thus obtaining an integrated synthetic value, and applying the integrated synthetic value to an approximation established in advance so as to calculate velocity of the subject.

Thus, the present invention provides a method and an apparatus capable of calculating walking or running velocity with practically acceptable accuracy, with a simple structure.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a functional block diagram showing a configuration of a velocity calculation apparatus according to an embodiment of the present invention;

FIG. 2 is a front view showing the velocity calculation apparatus;

FIG. 3 is a schematic graph showing a waveform of synthetic acceleration and an integrated synthetic value;

FIG. 4 is a flowchart showing an overall process of a velocity calculation method according to the embodiment;

FIG. 5 is a flowchart showing a detailed process of a velocity calculation step;

FIGS. 6A to 6C are graphs showing results of examples 1-1 to 1-3, respectively;

FIGS. 7A to 7C are graphs showing results of examples 2-1 to 2-3, respectively;

FIGS. 8A to 8C are graphs showing results of examples 3-1 to 3-3, respectively; and

FIGS. 9A to 9C are graphs showing results of comparative examples 1-1 to 1-3, respectively.

### DETAILED DESCRIPTION

The invention will be now described herein with reference to illustrative embodiments. Those skilled in the art will recognize that many alternative embodiments can be accomplished using the teachings of the present invention and that the invention is not limited to the embodiments illustrated for explanatory purposes.

Hereafter, an embodiment of the present invention will be described referring to the drawings. In all the drawings, the same constituents will be given the same numeral and the description thereof will not be repeated.

Although a plurality of steps is sequentially stated in the following description of the velocity calculation method according to the present invention, such sequence in no way limits the order or timing for practically performing those steps. The order of the plurality of steps may be modified when performing the velocity calculation method according to the present invention unless technical inconvenience is incurred, and the execution timing of one of the steps may partially or entirely overlap that of another.

It is to be noted that specific hardware configuration of the velocity calculation apparatus according to the present invention is not limited as long as the constituents thereof are capable of performing the intended function. The constituents may be realized, for example, as an exclusive hardware that performs a predetermined function, a data processor in which a predetermined function is incorporated as a computer program, a predetermined function realized in a data processor by a computer program, and an optional combination thereof. Further, the velocity calculation apparatus may be constituted of hardware composed of general-use devices such as a central processing unit (CPU), a read-only memory (ROM), a random access memory (RAM), and an interface (I/F) unit, an exclusive logic circuit designed so as to perform a predetermined process, and a combination of those mentioned above, for reading the computer program and executing the relevant process accordingly.

In particular, approximations of velocity according to the present invention may be realized as a table stored in a storage unit in which coefficients, input values and output values satisfy the approximation, an exclusive logic circuit driven in accordance with the approximation, and so forth.

### [Velocity Calculation Apparatus]

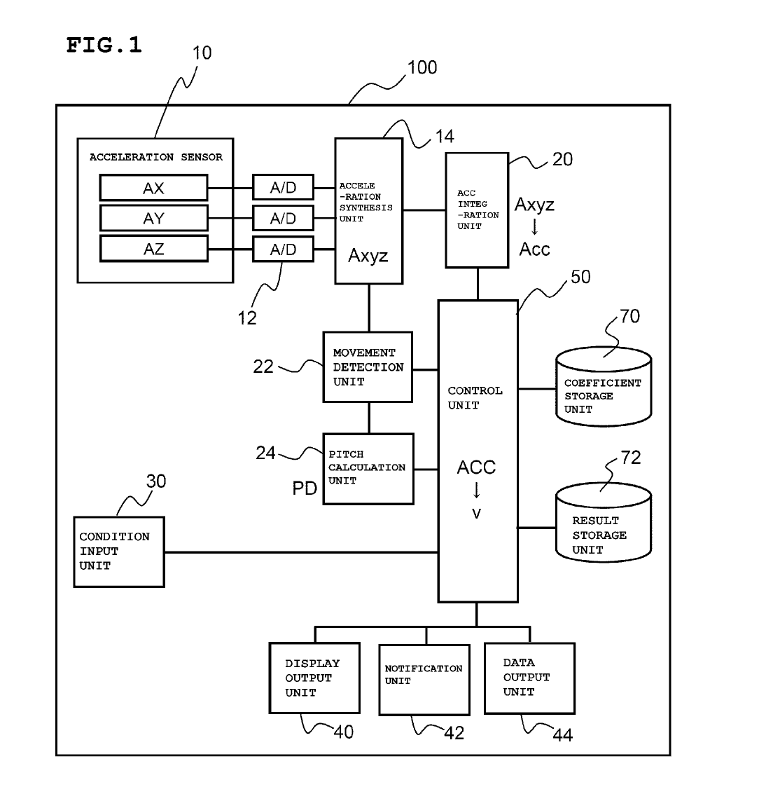

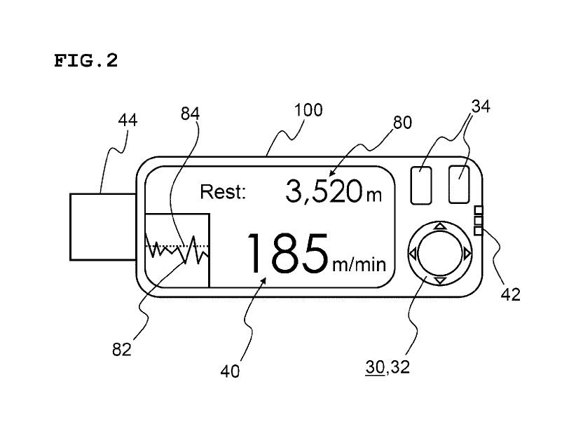

FIG. 1 is a functional block diagram showing a configuration of the velocity calculation apparatus according to the embodiment of the present invention. FIG. 2 is a front view showing the velocity calculation apparatus according to this embodiment.

To start with, an outline of this embodiment will be described. The velocity calculation apparatus 100 includes an acceleration sensor 10, an Acc integration unit 20 and a control unit 50.

The acceleration sensor 10 serves to measure acceleration of a walking or running subject. The acceleration sensor 10 measures monoaxial, orthogonal biaxial, or orthogonal triaxial acceleration.

In the case where the acceleration sensor 10 is a monoaxial sensor, the acceleration sensor 10 is attached to the subject such that the measurement direction is aligned with the gravity direction, in other words the up-and-down direction of the subject. In the case where the acceleration sensor 10 is an orthogonal biaxial sensor, which measures acceleration in two directions orthogonal to each other, the acceleration sensor 10 is attached to the subject such that one of the measurement directions is aligned with the gravity direction, and that the other measurement direction is aligned with the front-and-back or left-and-right direction of the walking (running) direction of the subject. In walking or running activities, acceleration originating from vibration in the vertical direction is mainly detected, and therefore it is preferable to set the measurement direction in the vertical direction.

In the case where the acceleration sensor 10 is an orthogonal triaxial sensor configured so as to measure acceleration in three directions orthogonal to each other, the acceleration sensor 10 may be attached to the subject in any desired direction. The following description refers to the case where the acceleration sensor 10 serves to measure acceleration in orthogonal triaxial directions of the subject.

The Acc integration unit 20 serves to integrate a synthetic acceleration Axyz, obtained by synthesizing the acceleration measured by the acceleration sensor 10, during a unit time UT which is longer than a walking or running cycle, to thereby obtain an integrated synthetic value Acc. The control unit 50 is a velocity calculation unit that applies the integrated synthetic value Acc to an approximation established in advance, so as to calculate velocity v of the subject. Here, in the case where the acceleration sensor 10 is a monoaxial sensor, the Acc integration unit 20 integrates the acceleration measured by the acceleration sensor 10 during a unit time UT, to thereby obtain the integrated synthetic value Acc.

This embodiment will now be described in further details here below. It is to be noted that the synthesis method of the synthetic acceleration Axyz, the calculation method of the integrated synthetic value Acc, and the detection method performed by a movement detection unit 22 are merely exemplary, and that the present invention is in no way limited to those examples.

The velocity calculation apparatus 100 is portable, and can be attached to the body or clothes of the subject (user), or carried by the subject in a bag or the like. The velocity calculation apparatus 100 calculates the moving velocity of the walking or running subject (walking velocity or running velocity) in the travelling direction, by approximate operation. Hereafter, the term “walking” may also imply “running”, without clear distinction therebetween.

The velocity calculation apparatus 100 according to this embodiment displays the calculated velocity v on a display output unit 40. The velocity data indicating the velocity v is recorded in a result storage unit 72. The velocity data can be read out from a data output unit 44 by a computer (not shown).

Without limitation to this embodiment, another physical amount (for example, covered distance) maybe worked out from the calculated velocity v, and such another physical amount may be displayed on the display output unit 40. In other words, the velocity calculation apparatus 100 according to this embodiment calculates the velocity v of the subject either in the process of producing and outputting the velocity v, or in the process of calculating another physical amount.

In this embodiment, the calculated velocity v is outputted on the display output unit 40. In addition, the transition of the velocity v is outputted on a velocity history display unit 82. The velocity history display unit 82 serves to generate graphical representation of the transition with time of the calculated velocity v, and to display the same.

The control unit 50 according to this embodiment integrates the velocity v so as to calculate the distance covered by walking. A distance display unit 80 shown in FIG. 2 displays the distance covered by walking, or a remaining distance. The remaining distance is obtained by subtracting the distance covered by walking from a preset target distance TL.

The condition input unit 30 is an interface for the subject to input various conditions. The condition input unit 30 is composed of a dial 32, buttons 34 (see FIG. 2), and the like.

A notification unit 42 serves to output an alarm, when a difference VD between a preset target velocity TV and the calculated velocity v exceeds a predetermined threshold of divergence. Examples of the form of the alarm include verbal announcement, a signal, and a pulse. Accordingly, the notification unit 42 maybe exemplified by a speaker, a signal transmitter, and a pulse exciter. Outputting the alarm notifying that the difference VD between the target velocity TV and the calculated velocity v has exceeded the predetermined threshold facilitates the subject to maintain the aimed pace. A target velocity display unit 84 displays graphic representation of the preset target velocity TV.

The acceleration sensor 10 acquires acceleration AX in an X-axis direction, acceleration AY in a Y-axis direction, and acceleration AZ in a Z-axis direction, orthogonal to each other, as analog or digital data. It is not necessary that a given axis of the acceleration sensor 10 be aligned with the vertical direction or travelling direction of the subject. The subject may wear or carry the velocity calculation apparatus 100 in any desired orientation.

An A/D conversion unit 12 performs sampling of waveforms of the respective axes outputted by the acceleration sensor 10 at predetermined time intervals, to thereby acquire acceleration data (digital data). An acceleration synthesis unit 14 synthesizes the acceleration data of the orthogonal triaxial directions acquired by the A/D conversion unit 12, to thereby generate the synthetic acceleration Axyz. The synthetic acceleration Axyz is the square root of sum of squares of AX, AY, and AZ.

The Acc integration unit 20 integrates the synthetic acceleration Axyz during a predetermined unit time UT, to thereby generate the integrated synthetic value Acc.

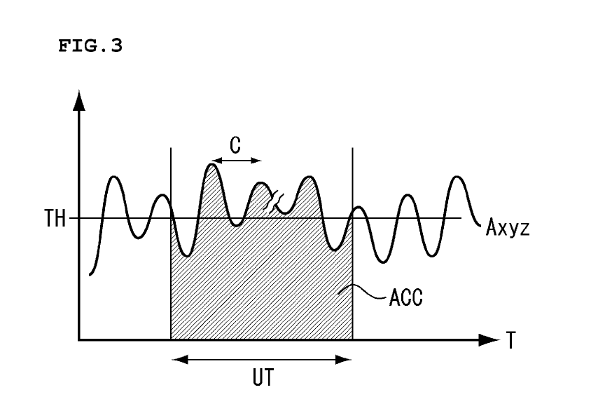

FIG. 3 is a graph showing a waveform of the synthetic acceleration Axyz and the integrated synthetic value Acc. In this graph, the horizontal axis represents the time T, and the vertical axis represents the acceleration. Unless the input from the acceleration sensor 10 is zero, the synthetic acceleration Axyz assumes a positive value. The integrated synthetic value Acc is a value obtained by integrating the synthetic acceleration Axyz during a unit time UT, which corresponds to the area of the region under the curved line in FIG. 3.

The acceleration synthesis unit 14 includes an analog or digital low-pass filter. A human's highest running pitch is approx. 240 steps/min.=4 steps/sec., which can be converted into 4 Hz. The low-pass filter removes acceleration noise of a frequency by far higher than 4 Hz from the synthetic acceleration Axyz. Such a configuration contributes to improving reproducibility of the integrated synthetic value Acc generated by the Acc integration unit 20.

The unit time UT is sufficiently longer than the walking cycle C of the subject. More specifically, the unit time UT may be set to be 10 times or more of the walking cycle C, more preferably 50 times or more. Setting thus the unit time UT that is sufficiently longer than the walking cycle C leads to reduced calculation error of the integrated synthetic value Acc that varies depending on measurement factors. Examples of the measurement factor include selection of a start time of the unit time UT, measurement noise of the acceleration sensor 10, and uneven walking pace of the subject.

In the case where the unit time UT is excessively long, it takes a long time before the velocity is calculated after starting the walking. In this case, in addition, fluctuation of the integrated synthetic value Acc is mitigated even when the walking velocity of the subject suddenly changes, and therefore the accuracy of the velocity calculation is degraded. In the velocity calculation apparatus 100 according to this embodiment, the unit time UT is set at 60 seconds. Since the walking cycle C of a human being is generally between one step/sec. (slow strolling) and 4 steps/sec. (high-speed running), the unit time UT according to this embodiment is between 15 times and 60 times of the walking cycle C.

Referring again to FIG. 1, the control unit 50 is an information processing unit including a CPU. The control unit 50 looks up a coefficient storage unit 70 and acquires an approximation (1) or (2) established in advance, as expressed below. The control unit 50 applies the integrated synthetic value Acc to the acquired approximation (1) or (2), to thereby calculate the velocity v of the subject. The fact that the approximations (1), (2) are highly correlated with the walking or running velocity v will be subsequently explained with reference to examples.

[Equation 1]

v=α·\sqrt{Acc×H}+γ (1)

[Equation 2]

v=α·\sqrt{Acc×H}+β·PD+γ (2)

The first term of the approximation (2) is the dominant term that assumes a larger value than the remaining terms (second term) other than a segment (γ). The dominant term (first term) of the approximation (2) is proportional to the radical root of the integrated synthetic value Acc. The radical root is expressed as 1/N-th power (N>1) of the base (integrated synthetic value Acc).

The approximation (2) includes the first term which is the dominant term, and the second term proportional to the number of steps PD. The number of steps PD corresponds to the number of steps per unit time UT.

The last term (segment) of the approximation (1), (2) is a constant term γ.

The dominant term of the approximation is the term that shows the largest absolute value |t| of the t-value of the explanatory variable, in the case where the approximation includes a plurality of explanatory variables, i.e., a plurality of terms other than the segment. In this embodiment, the approximation (2) corresponds to such a case. According to the present invention, in the case where the approximation is composed of a single explanatory variable, i.e., includes a single term other than the segment, the term of the explanatory variable will be referred to as the dominant term. In this embodiment, the approximation (1) and an approximation (3) to be cited later correspond to such cases.

More specifically, the dominant term (first term) of the approximation (2) is the radical root of the product of the integrated synthetic value Acc and the height H of the subject. In other words, the operation of the approximation (2) includes multiplying the square root (N=2) of the integrated synthetic value Acc by the square root of the height H of the subject. Thus, the dominant term of the approximation (2) is proportional to the product of the square root of the integrated synthetic value Acc and the square root of the height H of the subject. The unit system of the height H may be any of centimeter, meter, inch, and so forth. Differences between the unit systems are adjusted by the setting of the coefficient α of the first term.

A movement detection unit 22 of the velocity calculation apparatus 100 detects the occurrence of walking or running movement, on the basis of the synthetic acceleration Axyz. The movement detection unit 22 distinguishes between walking and running on the basis of a maximum value of the synthetic acceleration Axyz. A pitch calculation unit 24 counts the number of steps PD during a predetermined period of time (unit time UT, for example), and transmits the counted value to the control unit 50.

The coefficient storage unit 70 stores therein the approximations (1), (2). In this embodiment, the expression “coefficient storage unit 70 stores the approximations (1), (2)” means that the coefficient storage unit 70 stores the coefficient α, β, γ of the approximation (1), (2), the unit time UT, and a count threshold TH. The height H of the subject is inputted by the subject through the condition input unit 30.

The coefficients α, β, γ adopted when the acceleration sensor 10 is an orthogonal triaxial sensor, those adopted when the acceleration sensor 10 is a monoaxial sensor, and those adopted when the acceleration sensor 10 is an orthogonal biaxial sensor are different from each other. The coefficient storage unit 70 stores the coefficients α, β, γ specified in accordance with the number of measurement directions of the acceleration sensor 10 (in this embodiment, three directions).

The velocity calculation apparatus 100 may be configured so as to calculate the velocity v on the basis of one of the approximations (1) and (2). Alternatively, the approximations (1) and (2) may be selectively installed in the velocity calculation apparatus 100, so that either the approximation (1) or (2) is selected by an input by the subject through the condition input unit 30 or on the basis of other conditions, for calculation of the velocity v based on the selected approximation.

In this embodiment, the value of the coefficient α of the approximation (1) or (2) may be varied depending on the walking pitch of the subject. As will be subsequently described with reference to the examples, setting a larger coefficient α for running than for walking further upgrades the calculation accuracy of the velocity v. The integrated synthetic value Acc is smaller in walking than in running. Alternatively, the coefficient α may be varied in accordance with the magnitude of the integrated synthetic value Acc. More specifically, the coefficient α (first coefficient α1) by which the dominant term (first term) is multiplied when the integrated synthetic value Acc is below a predetermined threshold and the coefficient α (second coefficient α2) by which the dominant term (first term) is multiplied when the integrated synthetic value Acc is equal to or larger than the predetermined threshold may be made different from each other. It is preferable that the second coefficient α2 is larger than the first coefficient α1.

Without limitation to this embodiment, the control unit 50 may distinguish between walking and running on the basis of the detection information transmitted from the movement detection unit 22, instead of the magnitude of the integrated synthetic value Acc. In this case, the control unit 50 selects one of the first coefficient α1 for walking and the second coefficient α2 for running.

In the foregoing embodiment, the approximations (1), (2) including the radical root of the integrated synthetic value Acc have been described. It is to be noted, however, that the approximation applicable to the present invention is not limited to those cited above, provided that the integrated synthetic value Acc is involved. A linear function of the integrated synthetic value Acc may be adopted, as the following approximation (3). In the approximation (3), Wt represents the weight of the subject. In subsequent passages regarding the example 3, it will be explained that the approximation (3) also enables the velocity v to be calculated with practically acceptable accuracy.

[Equation 3]

v=α·Acc/Wt+γ (3)

### [Velocity Calculation Method]

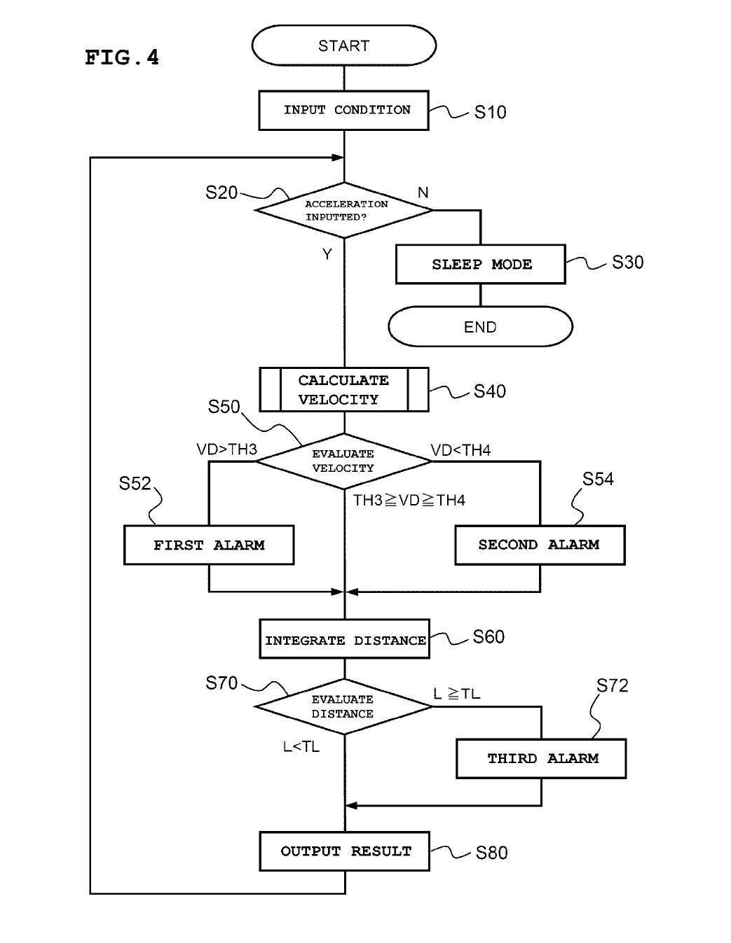

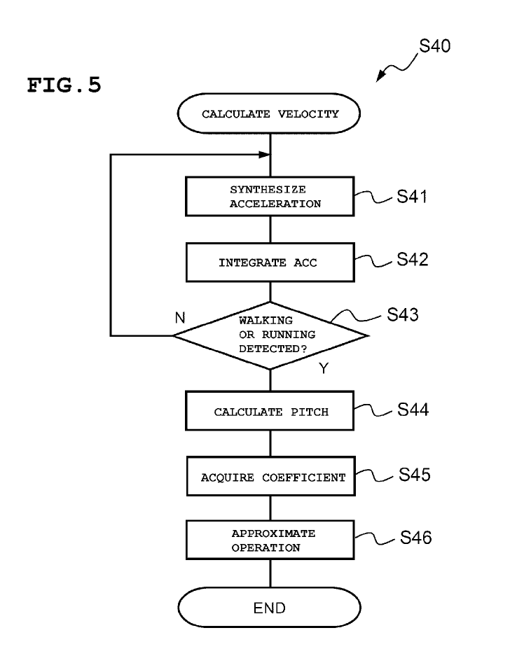

Hereafter, a velocity calculation method (simply method, as the case may be) to be performed by the velocity calculation apparatus 100 according to this embodiment will be described. FIG. 4 is a flowchart showing an overall process the method. FIG. 5 is a flowchart showing a detailed process of a velocity calculation step S40 in FIG. 4.

First, an outline of the method will be described.

In this method, the velocity calculation apparatus 100 measures the acceleration of the walking or running subject. More specifically, the velocity calculation apparatus 100 measures the acceleration in orthogonal triaxial directions of the subject (Y at step S20 in FIG. 4). The velocity calculation apparatus 100 may measure the acceleration of the subject in monoaxial direction aligned with the gravity direction, or the acceleration of the subject in orthogonal biaxial directions one of which is aligned with the gravity direction and the other is orthogonal to the one. The velocity calculation apparatus 100 applies a low-pass filter to the measured values of the acceleration in three directions, which is not mandatory, and synthesizes those values so as to generate the synthetic acceleration Axyz (step S41 in FIG. 5). The velocity calculation apparatus 100 integrates the synthetic acceleration Axyz during a unit time UT longer than the walking or running cycle, to thereby obtain the integrated synthetic value Acc (step S42 in FIG. 5). The velocity calculation apparatus 100 then applies the integrated synthetic value Acc to the approximation (1) or (2) established in advance, to thereby calculate the velocity v of the subject.

Hereunder, further details of the method will be described.

At a condition input step S10, the condition input unit 30 accepts inputs by the subject who is about to measure the velocity. The subject manipulates the dial 32 and buttons 34 (see FIG. 2) of the condition input unit 30 so as to input his/her height H, weight Wt, target velocity TV, and target distance TL.

The subject wears the velocity calculation apparatus 100 and starts to walk or run at predetermined velocity. At an acceleration input step S20, the velocity calculation apparatus 100 decides whether measured values of the acceleration AX, AY, and AZ in the X-axis, Y-axis, and Z-axis direction have been outputted from the acceleration sensor 10 or the A/D conversion unit 12. In the case where the measured values of the acceleration AX, AY, AZ have been outputted (Y at step S20 in FIG. 4), the process advances to the velocity calculation step S40. In the case where the measured values of the acceleration AX, AY, AZ have not been outputted, the velocity calculation apparatus 100 assumes that the subject is not moving and enters a sleep mode (step S30 in FIG. 4). In the case where the sleep mode is maintained for a predetermined period of time, the velocity calculation apparatus 100 turns the power off so as to finish the operation.

At the velocity calculation step S40, the acceleration synthesis unit 14 synthesizes the acceleration data of the orthogonal triaxial directions so as to generate the synthetic acceleration Axyz (step S41 in FIG. 5). The acceleration synthesis unit 14 removes high-frequency noise from the synthetic acceleration Axyz by using the low-pass filter.

Then the Acc integration unit 20 integrates the synthetic acceleration Axyz during a predetermined unit time UT so as to generate the integrated synthetic value Acc (step S42 in FIG. 5). The Acc integration unit 20 looks up the coefficient storage unit 70 to acquire the unit time UT, and digitizes the synthetic acceleration Axyz at predetermined sampling intervals and integrates the digital values. The Acc integration unit 20 continues the sampling of the synthetic acceleration Axyz while the subject is walking or running. The integrated synthetic value Acc at a given time point is the integrated value of the synthetic acceleration Axyz sampled between a past time point earlier by the unit time UT and the given time point. The Acc integration unit 20 updates the integrated synthetic value Acc time after time.

The movement detection unit 22 detects that the synthetic acceleration Axyz synthesized by the acceleration synthesis unit 14 has reached a predetermined count threshold TH (see FIG. 3). The pitch calculation unit 24 calculates the number of steps on the basis of the detection result from the movement detection unit 22.

More specifically, the movement detection unit 22 assumes that the subject has started to walk or run when a first condition and a second condition are both satisfied (Y at step S43 in FIG. 5), and increments the number of steps PD. The first condition is that the value of the synthetic acceleration Axyz thus far below the count threshold TH exceeds the count threshold TH. The second condition is that the time elapsed since a previous exceeding of the count threshold TH is within a predetermined range (for example, between 0.25 and 1 second). In the case where the walking or running motion has not been detected (N at step S43 in FIG. 5), the acceleration synthesis unit 14 again acquires the acceleration AX, AY, AZ from the acceleration sensor 10, and synthesizes these values (step S41 in FIG. 5).

The pitch calculation unit 24 counts the number of steps PD during a predetermined period of time (unit time UT, for example) (step S44 in FIG. 5), and transmits the counted number to the control unit 50. The movement detection unit 22 distinguishes between walking and running on the basis of a maximal value of the synthetic acceleration Axyz. More specifically, the movement detection unit 22 decides that the subject is running when the maximal value of the synthetic acceleration Axyz is larger than a predetermined acceleration threshold. The detection information from the movement detection unit 22 indicating whether the subject is walking or running is transmitted to the control unit 50.

Here, each of the step S42 and the steps S43 to S44 maybe performed before the remaining steps, and two or more of those steps may be performed at a time.

The control unit 50 acquires a necessary one out of the coefficients α, β, γ of the approximation from the coefficient storage unit 70 (step S45 in FIG. 5). As will be subsequently described with reference to the examples, employing different coefficients α for the walking and running movements upgrades the calculation accuracy of the velocity v. It is preferable that the control unit 50 acquire the coefficients α, β, γ on the basis of the result transmitted from the movement detection unit 22 and the pitch calculation unit 24.

The control unit 50 then calculates the velocity v on the basis of the integrated synthetic value Acc, the number of steps PD, and the approximation composed of one of the coefficients α, β, γ, height H, and weight Wt acquired as above (step S46 in FIG. 5).

More specifically, the control unit 50 calculates the velocity v in accordance with the approximation (1), on the basis of the coefficients α and γ acquired upon looking up the coefficient storage unit 70, the integrated synthetic value Acc acquired from the Acc integration unit 20, and the height H inputted by the subject.

Alternatively, the control unit 50 may calculate the velocity v in accordance with the approximation (2), on the basis of the coefficients α, β, γ acquired upon looking up the coefficient storage unit 70, the integrated synthetic value Acc acquired from the Acc integration unit 20, the height H inputted by the subject, and the number of steps PD acquired from the pitch calculation unit 24. Further, the control unit 50 may calculate the velocity v in accordance with the approximation (3), on the basis of the coefficients α and γ acquired upon looking up the coefficient storage unit 70, the integrated synthetic value Acc acquired from the Acc integration unit 20, and the weight Wt inputted by the subject.

The velocity calculation step S40 is thus completed.

When the velocity v of the subject is calculated, the control unit 50 compares the velocity v with the target velocity TV. In this embodiment, the control unit 50 compares magnitudes between the difference VD obtained by subtracting the target velocity TV from the velocity v (=v−VD), and a positive threshold of divergence TH3 and a negative threshold of divergence TH4 (step S50 in FIG. 4).

In the case where the difference VD is not smaller than TH4 and not larger than TH3 (TH3≧VD≧TH4 in step S50), the control unit 50 decides that the subject is generally maintaining the normal pace in accordance with the target velocity TV, and proceeds to a distance integration step S60 without outputting an alarm. In the case where the difference VD exceeds TH3 (VD>TH3 in step S50), the control unit 50 decides that the subject is over-paced beyond the target velocity TV, and causes the notification unit 42 to output an alarm in a first form (step S52 in FIG. 5). In the case where the difference VD is smaller than TH4 (VD<TH4 in step S50), the control unit 50 decides that the subject is under-paced below the target velocity TV, and causes the notification unit 42 to output an alarm in a second form (step S54 in FIG. 5). It is preferable that the alarm of the second form be arranged so as to encourage the subject to raise the pace, for example tones of a faster pitch than the alarm of the first form.

At the distance integration step S60, the control unit 50 calculates a distance L covered by walking or running, by integrating the velocity v.

At a distance evaluation step S70, the control unit 50 decides whether the covered distance L has reached the target distance TL. In the case where the covered distance L is equal to or longer than the target distance TL (L TL in step S70), the notification unit 42 outputs a notice in a third form indicating that the target has been achieved (FIG. 5: step S72). In the case where the covered distance L is shorter than the target distance TL (L<TL in step S70), the control unit 50 proceeds to a result output step 80 without outputting a notice from the notification unit 42.

At the result output step S80, the velocity v is displayed on the display output unit 40 and the velocity history display unit 82, and a remaining distance LR representing a difference between the target distance TL and the covered distance L is displayed on the distance display unit 80 (see FIG. 2).

The velocity calculation apparatus 100 returns to the acceleration input step S20, and continues to calculate the integrated synthetic value Acc and the velocity v, as long as the subject keeps walking or running.

The velocity calculation apparatus 100 thus performs the method according to the present invention. The velocity calculation apparatus 100 is a data processing unit in which the foregoing function is installed as a computer program.

The computer program is designed for use in the velocity calculation apparatus 100 including the acceleration sensor 10 that measures acceleration of the walking or running subject. The computer program causes the velocity calculation apparatus 100 to integrate synthetic acceleration obtained by synthesizing the acceleration measured by the acceleration sensor 10 during the unit time longer than the walking or running cycle thus to obtain the integrated synthetic value, and apply the integrated synthetic value to the approximation established in advance so as to calculate velocity of the subject. The acceleration sensor 10 may measure the acceleration in orthogonal triaxial directions of the subject. The acceleration sensor 10 may also measure the acceleration of the subject in monoaxial direction aligned with the gravity direction, or the acceleration of the subject in orthogonal biaxial directions one of which is aligned with the gravity direction and the other is orthogonal to the one.

Now, in the case where the velocity is calculated by simple integration of the synthetic acceleration measured by the acceleration sensor attached to the subject, a significant error is incurred. This is because the movement of a walking or running person produces a large amount of acceleration not only in the travelling direction but also in the gravity direction, i.e., vertical direction. Accordingly, simply integrating the triaxial synthetic acceleration allows acceleration components in the vertical direction to be incorporated in the integrated value, thus leading to overestimation of the velocity in the travelling direction. Nevertheless, it is difficult to extract only the acceleration in the travelling direction from individual acceleration values measured by the acceleration sensor before the triaxial synthesis. In this embodiment, however, the radical root of the integrated synthetic value, obtained by synthesizing the synthetic acceleration in the orthogonal triaxial directions during a period sufficiently longer than the walking or running cycle, is employed as the random variable. Therefore, the velocity of the subject can be calculated with practically acceptable accuracy simply by applying the integrated synthetic value to the approximation established in advance, which is an operation that barely imposes a computational load.

Naturally, various modifications may be made to the foregoing embodiment.

For example, the control unit 50 may calculate the stride length of the subject, and notify, in the event of overachievement or underachievement of the target pace, the current stride length to the subject. More specifically, the control unit 50 calculates the stride length of the subject on the basis of the number of steps PD acquired from the pitch calculation unit 24 and the calculated velocity v. Then the control unit 50 stores the stride length realized while the subject is walking at the normal pace (TH3≧VD≧TH4 in step S50) in the result storage unit 72, and calculates the average (normal average stride AST).

In the case where the subject is over-paced or under-paced (VD>TH3 or VD<TH4 in step S50), the control unit 50 calculates a ratio of the current stride to the normal average stride AST (stride ratio). Then the control unit 50 outputs a notice indicating that the stride ratio is equal to or larger than 1 or smaller than 1, when outputting the first alarm at the step S52 or the second alarm at the step S54. Accordingly, the walking or running subject can recognize whether the reason of the overachievement (or underachievement) is extended (or shortened) stride length or too fast (or too slow) pitch, on a real-time basis. Such an arrangement allows the subject to keep walking or running at an ideal stride length and pitch.

According to the foregoing embodiment, the unit time UT is a fixed value. Instead, the unit time UT may be set, in accordance with the walking cycle C calculated by the pitch calculation unit 24, to be a constant multiple (for example, 50 times) of the walking cycle. Such an arrangement allows an appropriate integrated synthetic value Acc to be automatically calculated, irrespective of the walking (running) velocity of the subject. In this case, it is preferable to adjust in advance the coefficient α of the approximations (1) to (3) in different values, in accordance with the length of the unit time UT. This is because the integrated synthetic value Acc increases generally proportionally to the unit time UT. Accordingly, it is preferable to adjust the coefficient α such that the first term of the approximations (1) to (3) assumes an equivalent value irrespective of the setting of the unit time UT. In the case, for example, where the unit time UT is set to be twice as long as a given reference condition, the first term of the approximations (1) and (2) assume an equivalent value by multiplying the coefficient α by 1/√2. For the approximation (3), the coefficient α may be multiplied by ½.

Thus, in the case of adopting the variable unit time UT, it is preferable to multiply the coefficient α by the reciprocal of the radical root of the ratio of the unit time UT with respect to the reference condition for the approximations (1) and (2), and the reciprocal of that ratio for the approximation (3). With such an arrangement, the output of the velocity v can maintain statistical validity.

The present invention will now be described more specifically on the basis of the examples. However, the present invention is in no way limited to the examples given below.

### EXAMPLE 1

The integrated synthetic value Acc was calculated on the basis of values measured by an acceleration sensor attached to testees walking or running at a velocity (actually measured velocity) between 3 km/h and 11 km/h. The unit time UT was set as 60 seconds. Then the velocity v (predicted velocity) was calculated in accordance with the approximation (1), on the basis of the integrated synthetic value Acc and the height H [m] of the testee.

[Equation 4]

v=α·\sqrt{Acc×H}+γ (1)

A plurality of values within the aforementioned velocity range were designated to the testees, and the actually measured velocity and the integrated synthetic value Acc were individually calculated with respect to each of those designated values. Which of the stride length and the pitch was to be adjusted to change the walking or running velocity was left to the option of the testees. Accordingly, the testees include those who increase the stride length to increase the walking or running velocity, those who increase the pitch keeping the pitch unchanged, and those who increase both the stride length and the pitch.

### EXAMPLE 1-1

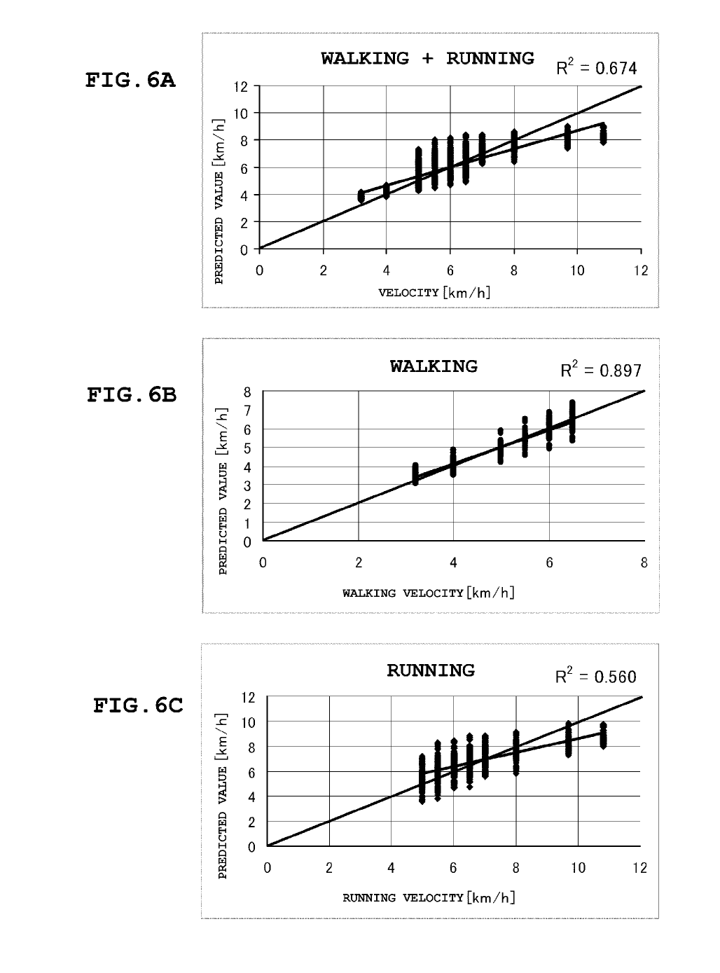

FIG. 6A is a graph in which the correspondence between the velocity (actually measured velocity) represented by the horizontal axis and the calculation result (predicted velocity) represented by the vertical axis is plotted with respect to a gross total of 1801 cases, in which the testees and the velocity are different.

### EXAMPLE 1-2

FIG. 6B is a graph in which, as FIG. 6A, the correspondence between the actually measured velocity and the calculation result (predicted velocity) is plotted with respect to totally 828 cases, in which the testees were walking.

### EXAMPLE 1-3

FIG. 6C is a graph in which, as FIG. 6A, the correspondence between the actually measured velocity and the calculation result (predicted velocity) is plotted with respect to totally 973 cases, in which the testees were running.

With respect to the examples 1-1 to 1-3, Pearson product-moment correlation coefficients and coefficients of determination adjusted for degrees of freedom (hereinafter, simply “adjusted coefficient of determination”) were calculated. In addition, the coefficients α and γ of the approximation (1) were calculated through simple regression analysis utilizing the square roots of the integrated synthetic value Acc and the height H as the explanatory variable. The coefficient γ is a segment.

The results from the example 1-1 based on the entire data of walking and running are shown in Table 1 given below. The results from the example 1-2 regarding the walking testees are shown in Table 2 given below. The results from the example 1-3 regarding the running testees are shown in Table 3 given below. In Tables 1 to 3, the Pearson product-moment correlation coefficient and the adjusted coefficient of determination are shown in two significant digits.

### EXAMPLE 2

The number of steps PD per unit time was counted, and the velocity v (predicted velocity) was calculated in accordance with the following approximation (2).

[Equation 5]

v=α·\sqrt{Acc×H}+β·PD+γ (2)

### EXAMPLE 2-1

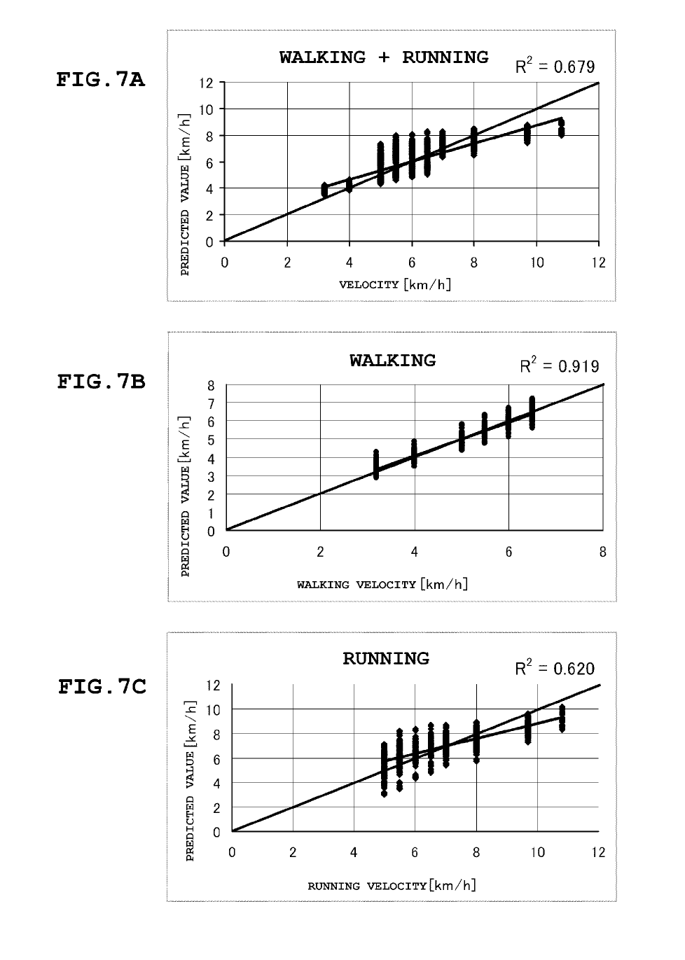

FIG. 7A is a graph in which, as in the example 1-1, the correspondence between the actually measured velocity and the predicted velocity is plotted with respect to the total of 1801 cases.

### EXAMPLE 2-2

FIG. 7B is a graph in which, as in the example 1-2, the correspondence between the actually measured velocity and the predicted velocity is plotted with respect to the 828 cases in which the testees were walking.

### EXAMPLE 2-3

FIG. 7C is a graph in which, as in the example 1-3, the correspondence between the actually measured velocity and the predicted velocity is plotted with respect to the 973 cases in which the testees were running.

As the example 1, the Pearson product-moment correlation coefficient and the adjusted coefficient of determination were calculated. The coefficients α, β, γ of the approximation (2) were calculated through multiple regression analysis utilizing the square roots of the integrated synthetic value Acc and the height H, and the number of steps PD, as the explanatory variable. The coefficient γ is a segment. In addition, absolute values |t| of the coefficients α and β were calculated. The term having the larger |t| is the dominant term.

The results from the example 2-1 based on the entire data of walking and running are shown in Table 1. The results from the example 2-2 regarding the walking testees are shown in Table 2. The results from the example 2-3 regarding the running testees are shown in Table 3.

In all the examples 2-1 to 2-3, the value |t| of the first term (coefficient α) was larger than |t| of the second term (coefficient β). Accordingly, it has been confirmed that the first term including the radical root of the integrated synthetic value Acc is the dominant term.

### EXAMPLE 3

The velocity v (predicted velocity) was calculated in accordance with the following approximation (3) based on the weight Wt of the testee and the integrated synthetic value Acc.

[Equation 6]

v=α·Acc/Wt+γ (3)

### EXAMPLE 3-1

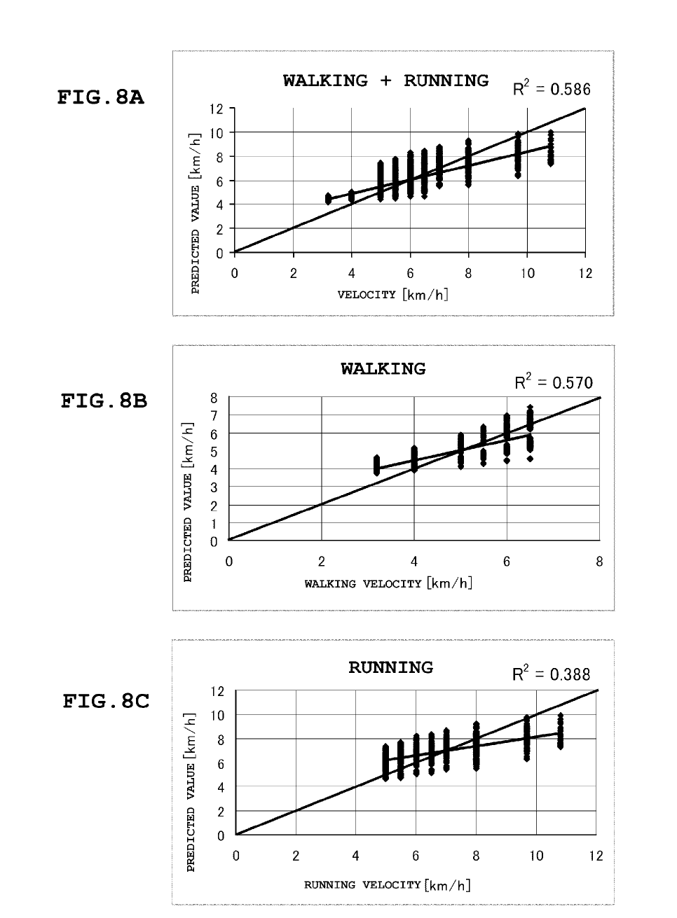

FIG. 8A is a graph in which, as in the example 1-1, the correspondence between the actually measured velocity and the predicted velocity is plotted with respect to the total of 1801 cases.

### EXAMPLE 3-2

FIG. 8B is a graph in which, as in the example 1-2, the correspondence between the actually measured velocity and the predicted velocity is plotted with respect to the 828 cases in which the testees were walking.

### EXAMPLE 3-3

FIG. 8C is a graph in which, as in the example 1-3, the correspondence between the actually measured velocity and the predicted velocity is plotted with respect to the 973 cases in which the testees were running.

As in the examples 1, 2, the Pearson product-moment correlation coefficient and the adjusted coefficient of determination were calculated. In addition, the coefficients α and γ of the approximation (3) were calculated through simple regression analysis utilizing the integrated synthetic value Acc/weight Wt as the explanatory variable. The coefficient γ is a segment.

The results from the example 3-1 based on the entire data of walking and running are shown in Table 1. The results from the example 3-2 regarding the walking testees are shown in Table 2. The results from the example 3-3 regarding the running testees are shown in Table 3.

### COMPARATIVE EXAMPLE 1

The velocity v (predicted velocity) was calculated by multiplying a fixed stride length by the number of steps PD per unit time with respect to each of the testees, without involving the integrated synthetic value Acc. This corresponds to the calculation method according to JP-A-H5-164571. Although the stride length is uniformly fixed (for example, 60 cm) for all the testees according to JP-A-H5-164571, in the comparative example 1 different stride lengths were set for the testees in accordance with the respective height, in order to improve the calculation accuracy compared with JP-A-H5-164571. Specifically, the stride length was set as testee's height H−1.0 [m].

[Equation 7]

v=(H−1.0)·PD (4)

### COMPARATIVE EXAMPLE 1-1

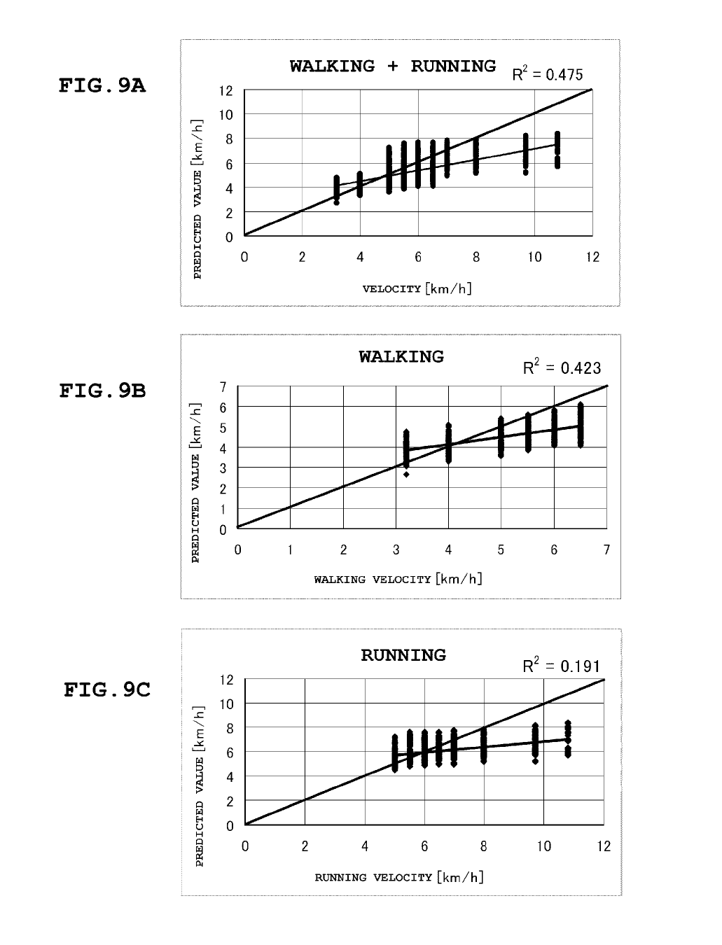

FIG. 9A is a graph in which, as in the example 1-1, the correspondence between the actually measured velocity and the predicted velocity is plotted with respect to the total of 1801 cases.

### COMPARATIVE EXAMPLE 1-2

FIG. 9B is a graph in which, as in the example 1-2, the correspondence between the actually measured velocity and the predicted velocity is plotted with respect to the 828 cases in which the testees were walking.

### COMPARATIVE EXAMPLE 1-3

FIG. 9C is a graph in which, as in the example 1-3, the correspondence between the actually measured velocity and the predicted velocity is plotted with respect to the 973 cases in which the testees were running.

As in the examples 1 to 3, the Pearson product-moment correlation coefficient and the adjusted coefficient of determination were calculated.

The results from the comparative example 1-1 based on the entire data of walking and running are shown in Table 1. The results from the comparative example 1-2 regarding the walking testees are shown in Table 2. The results from the comparative example 1-3 regarding the running testees are shown in Table 3.

TABLE 1
(Walking + running)

| | IE1 | IE2 | IE3 | CE1 |
|---|---|---|---|---|
| Pearson product-moment | 0.67 | 0.68 | 0.59 | 0.48 |
| correlation coefficient (R²) | | | | |
| Adjusted coefficient of | 0.67 | 0.68 | 0.59 | 0.48 |
| determination | | | | |
| Coefficient α | 6.71E−03 | 5.53E−03 | 3.84E−04 | — |
| Coefficient β | — | 1.05E−02 | — | — |
| Coefficient γ | 1.16 | 5.53E−03 | 3.79 | — |
| \|t\| (α) | — | 22.53 | — | — |
| \|t\| (β) | — | 5.34 | — | — |

(IE = Example, CE = Comparative example)

TABLE 2
(Walking)

| | IE1 | IE2 | IE3 | CE1 |
|---|---|---|---|---|
| Pearson product-moment | 0.90 | 0.92 | 0.57 | 0.42 |
| correlation coefficient (R²) | | | | |
| Adjusted coefficient of | 0.90 | 0.92 | 0.57 | 0.42 |
| determination | | | | |
| Coefficient α | 1.13E−02 | 9.17E−03 | 6.61E−04 | — |
| Coefficient β | — | 1.98E−02 | — | — |
| Coefficient γ | −1.06 | −2.25 | 3.01 | — |
| \|t\| (α) | — | 48.35 | — | — |
| \|t\| (β) | — | 14.69 | — | — |

TABLE 3
(Running)

| | IE1 | IE2 | IE3 | CE1 |
|---|---|---|---|---|
| Pearson product-moment | 0.56 | 0.62 | 0.39 | 0.19 |
| correlation coefficient (R²) | | | | |
| Adjusted coefficient of | 0.56 | 0.62 | 0.39 | 0.19 |
| determination | | | | |
| Coefficient α | 1.02E−02 | 8.06E−03 | 3.79E−04 | — |
| Coefficient β | — | 3.30E−02 | — | — |
| Coefficient γ | −2.21 | −5.63 | 3.75 | — |
| \|t\| (α) | — | 25.02 | — | — |
| \|t\| (β) | — | 12.35 | — | — |

Through the comparison of the results from the examples 1 to 3 and the comparative example 1, the following facts have been revealed.

(a) A regression equation has been established that allows the actually measured velocity to be accurately simulated by regression analysis utilizing the integrated synthetic value Acc as the explanatory variable. With respect to the entire cases including both the walking and running data, the Pearson product-moment correlation coefficient (R²) was 0.48 in the comparative example 1, while the same coefficient (R²) exceeded 0.5 in all the examples 1 to 3. The correlation coefficient (R), which is the square root of the Pearson product-moment correlation coefficient (R²), was below 0.7 in the comparative example 1, while the correlation coefficient (R) exceeded 0.7 in all the examples 1 to 3. Such results show that the examples 1 to 3 have achieved high correlation between the actually measured velocity and the predicted velocity. Accordingly, it has been proven that the actually measured velocity can be simulated with high accuracy by converting the integrated synthetic value Acc into the velocity v, even when the relationship between fluctuation of the walking (running) velocity and fluctuation of the stride length is different among the testees.

(b) In particular, by employing the approximations (1) and (2), having the dominant term that includes the radical root of the integrated synthetic value Acc, the calculation accuracy of the walking velocity and running velocity is further improved. In the examples 1 and 2, the Pearson product-moment correlation coefficient (R²) exceeded 0.64. This means that the correlation coefficient (R) is beyond 0.8, which shows that the actually measured velocity and the predicted velocity are highly correlated with each other.

(c) Further, regarding the cases where the testees were walking, the Pearson product-moment correlation coefficient (R²) reached 0.90 or even higher in the examples 1 and 2, as shown in Table 2. Presumably, this is because the acceleration component in the vertical direction contained in the output of the acceleration sensor 10 is relatively small in the walking movement, and hence high correlation is presented between the integrated synthetic value Acc and the walking speed. Such a result shows that it is preferable to adopt different values for the coefficient α of the dominant term, depending on whether the testee is walking or running.

(d) In all of the examples 1 to 3 and the comparative example 1, the adjusted coefficient of determination and the Pearson product-moment correlation coefficient have turned out to be equivalent. This means that the number of sample cases of the examples 1 to 3 was sufficiently large, and therefore the validity of the present invention has been statistically verified.

The foregoing embodiment and the examples encompass the following technical idea.

(1) A method of calculating velocity including measuring acceleration in orthogonal triaxial directions of a walking or running subject, integrating synthetic acceleration obtained by synthesizing the acceleration during a unit time longer than a walking or running cycle thus obtaining an integrated synthetic value, and applying the integrated synthetic value to an approximation established in advance, thereby calculating velocity of the subject.

(2) The method according to (1) above, wherein a dominant term of the approximation is proportional to the radical root of the integrated synthetic value.

(3) The method according to (2) above, further including multiplying the square root of the integrated synthetic value by the square root of the height of the subject, in the dominant term.

(4) The method according to (3) above, wherein the approximation includes a first term corresponding to the dominant term and a second term proportional to the number of steps.

(5) The method according to (4) above, further including detecting whether the acceleration of the subject measured has reached a predetermined count threshold, and calculating the number of steps upon detecting that the acceleration has reached the predetermined count threshold.

(6) The method according to any one of (2) to (5) above, wherein a first coefficient by which the dominant term is multiplied when the integrated synthetic value is below a predetermined threshold and a second coefficient by which the dominant term is multiplied when the integrated synthetic value is equal to or larger than the predetermined threshold are different, and the second coefficient is larger than the first coefficient.

(7) The method according to any one of (1) to (6) above, further including outputting an alarm when a difference between predetermined target velocity and the calculated velocity exceeds a predetermined threshold of divergence.

(8) A velocity calculation apparatus including an acceleration sensor that measures acceleration in orthogonal triaxial directions of a walking or running subject, an integration unit that integrates synthetic acceleration obtained by synthesizing the acceleration measured by the acceleration sensor, during a unit time longer than a walking or running cycle thus to obtain an integrated synthetic value, and a velocity calculation unit that applies the integrated synthetic value to the approximation to thereby calculate velocity of the subject.

(9) A computer program for a velocity calculation apparatus that includes an acceleration sensor that measures acceleration in orthogonal triaxial directions of a walking or running subject, for causing the velocity calculation apparatus to integrate synthetic acceleration obtained by synthesizing the acceleration measured by the acceleration sensor, during a unit time longer than a walking or running cycle thus to obtain an integrated synthetic value, and to apply the integrated synthetic value to an approximation established in advance so as to calculate velocity of the subject.

Further, the foregoing embodiment and the examples encompass the following technical idea.

(i) A method of calculating velocity including measuring acceleration of a walking or running subject, integrating the acceleration during a unit time longer than a walking or running cycle thus obtaining an integrated synthetic value, and applying the integrated synthetic value to an approximation established in advance, thereby calculating velocity of the subject.

(ii) The method according to (i) above, wherein the measuring acceleration includes measuring acceleration in a monoaxial direction aligned with the gravity direction or acceleration in orthogonal biaxial directions including the direction aligned with the gravity direction and another direction orthogonal thereto, and the integrating the acceleration includes integrating the acceleration in the monoaxial direction or integrating synthetic acceleration obtained by synthesizing the acceleration in the orthogonal biaxial directions during the unit time, thus obtaining the integrated synthetic value.

i) A velocity calculation apparatus including an acceleration sensor that measures acceleration of a walking or running subject, an integration unit that integrates the acceleration measured by the acceleration sensor, during a unit time longer than a walking or running cycle thus to obtain an integrated synthetic value, a storage unit containing an approximation established in advance, and a velocity calculation unit that refers the storage unit and applies the integrated synthetic value to the approximation to thereby calculate velocity of the subject.

(iv) The velocity calculation apparatus according to (iii) above, wherein the acceleration sensor measures acceleration in a monoaxial direction aligned with the gravity direction or acceleration in orthogonal biaxial directions including the direction aligned with the gravity direction and another direction orthogonal thereto, and the integration unit integrates the acceleration in the monoaxial direction or integrating synthetic acceleration obtained by synthesizing the acceleration in the orthogonal biaxial directions during the unit time, thus to obtain the integrated synthetic value.

(v) The velocity calculation apparatus according to (iii) above, wherein a dominant term of the approximation is proportional to the radical root of the integrated synthetic value.

(vi) The velocity calculation apparatus according to (v) above, wherein the dominant term is proportional to the product of the square root of the integrated synthetic value and the square root of the height of the subject.

(vii) The velocity calculation apparatus according to (vi) above, wherein the approximation includes a first term corresponding to the dominant term and a second term proportional to the number of steps.

(viii) The velocity calculation apparatus according to (vii) above, further including a movement detection unit that detects whether the acceleration of the subject measured has reached a predetermined count threshold, and a pitch calculation unit that calculates the number of steps upon detecting that the acceleration has reached the predetermined count threshold.

(ix) The velocity calculation apparatus according to (v) above, wherein the storage unit stores therein a first coefficient and a second coefficient larger than the first coefficient, and the velocity calculation unit multiplies the dominant term by the first coefficient when the integrated synthetic value is below a predetermined threshold, and by the second coefficient when the integrated synthetic value is equal to or larger than the predetermined threshold, to thereby calculate the velocity of the subject.

(x) The velocity calculation apparatus according to (iii) above, further including a notification unit that outputs an alarm when a difference between predetermined target velocity and the calculated velocity exceeds a predetermined threshold of divergence.

(xi) A computer program for causing a velocity calculation apparatus that includes an acceleration sensor that measures acceleration of a walking or running subject to perform a velocity calculation process, and a storage medium containing the computer program, wherein the velocity calculation process includes integrating the acceleration measured by the acceleration sensor, during a unit time longer than a walking or running cycle thus obtaining an integrated synthetic value, and applying the integrated synthetic value to an approximation established in advance so as to calculate velocity of the subject.

It is apparent that the present invention is not limited to the above embodiments, and maybe modified and changed without departing from the scope and spirit of the invention.

What is claimed is:

1. A method of calculating velocity, comprising:
measuring acceleration of a walking or running subject;
integrating the acceleration during a unit time longer than a walking or running cycle thus obtaining an integrated synthetic value; and
applying the integrated synthetic value to an approximation established in advance so as to calculate velocity of the subject.

2. The method according to claim 1,
wherein the measuring acceleration includes measuring the acceleration in orthogonal triaxial directions of the subject, and
the integrating the acceleration includes integrating synthetic acceleration obtained by synthesizing the measured acceleration in the orthogonal triaxial directions during the unit time, thus obtaining the integrated synthetic value.

3. The method according to claim 1,
wherein the measuring acceleration includes measuring acceleration in a monoaxial direction aligned with the gravity direction or acceleration in orthogonal biaxial directions including the direction aligned with the gravity direction and another direction orthogonal thereto, and
the integrating the acceleration includes integrating the acceleration in the monoaxial direction or integrating synthetic acceleration obtained by synthesizing the acceleration in the orthogonal biaxial directions during the unit time, thus obtaining the integrated synthetic value.

4. The method according to claim 1,
wherein a dominant term of the approximation is proportional to the radical root of the integrated synthetic value.

5. The method according to claim 4, further comprising:
multiplying the square root of the integrated synthetic value by the square root of the height of the subject, in the dominant term.

6. The method according to claim 5,
wherein the approximation includes a first term corresponding to the dominant term and a second term proportional to the number of steps.

7. The method according to claim 6, further comprising:
detecting whether the acceleration of the subject measured has reached a predetermined count threshold; and
calculating the number of steps upon detecting that the acceleration has reached the predetermined count threshold.

8. The method according to claim 4,
wherein a first coefficient by which the dominant term is multiplied when the integrated synthetic value is below a predetermined threshold and a second coefficient by which the dominant term is multiplied when the integrated synthetic value is equal to or larger than the predetermined threshold are different, and the second coefficient is larger than the first coefficient.

9. The method according to claim 1, further comprising:
outputting an alarm when a difference between predetermined target velocity and the calculated velocity exceeds a predetermined threshold of divergence.

10. A velocity calculation apparatus comprising:
an acceleration sensor that measures acceleration of a walking or running subject;
an integration unit that integrates the acceleration measured by the acceleration sensor, during a unit time longer than a walking or running cycle thus to obtain an integrated synthetic value;
a storage unit containing an approximation established in advance; and
a velocity calculation unit that refers the storage unit and applies the integrated synthetic value to the approximation so as to calculate velocity of the subject.

11. The velocity calculation apparatus according to claim 10,
wherein the acceleration sensor measures the acceleration in orthogonal triaxial directions of the subject, and
the integration unit integrates, during the unit time, synthetic acceleration obtained by synthesizing the acceleration in the orthogonal triaxial directions measured by the acceleration sensor, thus to obtain the integrated synthetic value.

12. The velocity calculation apparatus according to claim 10,
wherein the acceleration sensor measures acceleration in a monoaxial direction aligned with the gravity direction or acceleration in orthogonal biaxial directions including the direction aligned with the gravity direction and another direction orthogonal thereto, and
the integration unit integrates the acceleration in the monoaxial direction or integrating synthetic acceleration obtained by synthesizing the acceleration in the orthogonal biaxial directions during the unit time, thus to obtain the integrated synthetic value.

13. The velocity calculation apparatus according to claim 10,
wherein a dominant term of the approximation is proportional to the radical root of the integrated synthetic value.

14. The velocity calculation apparatus according to claim 13,
wherein the dominant term is proportional to the product of the square root of the integrated synthetic value and the square root of the height of the subject.

15. The velocity calculation apparatus according to claim 14,
wherein the approximation includes a first term corresponding to the dominant term and a second term proportional to the number of steps.

16. The velocity calculation apparatus according to claim 15, further comprising:
a movement detection unit that detects whether the acceleration of the subject measured has reached a predetermined count threshold; and
a pitch calculation unit that calculates the number of steps upon detecting that the acceleration has reached the predetermined count threshold.

17. The velocity calculation apparatus according to claim 13,
wherein the storage unit stores therein a first coefficient and a second coefficient larger than the first coefficient, and
the velocity calculation unit multiplies the dominant term by the first coefficient when the integrated synthetic value is below a predetermined threshold, and by the second coefficient when the integrated synthetic value is equal to or larger than the predetermined threshold, to thereby calculate the velocity of the subject.

18. The velocity calculation apparatus according to claim 10, further comprising:
a notification unit that outputs an alarm when a difference between predetermined target velocity and the calculated velocity exceeds a predetermined threshold of divergence.

19. A storage medium having a computer program stored thereon for causing a velocity calculation apparatus including an acceleration sensor that measures acceleration of a walking or running subject to perform a velocity calculation process,
wherein the velocity calculation process includes:
integrating the acceleration measured by the acceleration sensor during a unit time longer than a walking or running cycle thus obtaining an integrated synthetic value; and
applying the integrated synthetic value to an approximation established in advance so as to calculate velocity of the subject.

20. The storage medium according to claim 19,
wherein the integrating the acceleration includes integrating, during the unit time, synthetic acceleration obtained by synthesizing the acceleration in the orthogonal triaxial directions measured by the acceleration sensor, thus to obtain the integrated synthetic value.
